(19) United States
(12) Patent Application Publication
(10) Pub. No.: US 2007/0120619 A1
(43) Pub. Date: May 31, 2007

(54) RF switch

(75) Inventor: Brian Kearns, Dublin (IE)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/288,201

(22) Filed: Nov. 29, 2005

(51) Int. Cl. H01P 1/10

(52) U.S. Cl. 333/103

(57) ABSTRACT

An SPNT switch has at least two operating states and comprises N circuit branches. Each circuit branch comprises a first input/output port connected to a second input/output port via a series active device, and a phase shifting component connected in series with a shunt active device. When the shunt active device is in an on state, the reflection co-efficient due to a path to ground from the series active device via the phase shifting component and the shunt active device is +1. At least one DC terminal controls the state of the active devices, whereby in one of the operating states of the switch, both active devices are in the on state simultaneously, and in another of the operating states, both active devices are in an off state simultaneously.

### FIELD OF THE INVENTION

The present invention relates to an RF switch especially for use in antenna switch modules or RF modules for mobile devices.

### BACKGROUND OF THE INVENTION

Electronic switches which are suitable for radio frequency (RF) applications and which can be switched between several states of operation by the application of one or more bias voltages to one or more control terminals have widespread applications in such RF devices and components.

For example, modem cellular wireless telephony handsets are generally capable of operating on several different frequency bands and usually require an RF switch to alternately connect a single antenna to the various TX and RX circuit sections of the handset. The RF switch of a cellular handset is often grouped together with RF filters and other RF components in what is commonly referred to as an antenna switching module (ASM) or front end module (FEM). Various applications of RF switches in antenna switching modules are illustrated by Fukamachi et al in US patent application US20040266378A1. It can be seen that for these applications SP2T, SP3T and SP4T RF switches are required. Many other applications for RF switches exist, and the type of switch required is usually governed by parameters specific to the particular application.

An SP2T RF switch includes a common RF port, a first RF input/output port, and a second RF input/output port, the switch has an operation frequency range defined by a lower frequency limit f_{L} and an upper frequency limit f_{U}. An SP2T RF switch furthermore includes two circuit branches where each circuit branch comprises a first end and a second end. The first end of one circuit branch is connected to the first input/output port of the switch and the first end of the other circuit branch is connected to the second input/output port of the switch. The second ends of both circuit branches are connected to the common port of the switch. There are two states of operation of an SP2T RF switch: a first state of operation and a second state of operation. In the first state of operation, a low insertion loss path for RF signals within the operating frequency range of the switch exists between the first input/output port and the common port via one of the circuit branches, and simultaneously there is high isolation between the common port of the switch and the second input/output port for RF signals within the same frequency range; in the second state of operation, a low insertion loss path exists between the second input/output port and the common port via the other circuit branch for RF signals within the operating frequency range of the switch, and simultaneously there is high isolation between the common port of the switch and the first input/output port for RF signals within the same frequency range. Common embodiments of an SP2T RF can furthermore be switched between the first state of operation and the second state of operation actively by the application of a particular combination of control voltages to a number of control terminals of the switch.

A number of prior art embodiments of SP2T RF switches are described below; each prior art embodiment includes a first circuit branch and a second circuit branch where each circuit branch further includes one or more series or parallel active devices, where each active device has two states: an on state where the active devices presents a low impedance path to an RF signal, and an off state where the active devices presents a high impedance path to an RF signal, and where the state of the active device is controlled by the application of a bias voltage to the active device.

In U.S. Pat. No. 3,475,700, Ertel describes several transmit/receive SP2T RF switches which can alternately connect a TX port 14 or an RX port 16 to a common antenna 12. The switch depicted by Ertel in FIG. 1 of U.S. Pat. No. 3,475,700 comprises two series connected PIN diodes 18, 20, each of which can be switched between respective on-states and off-states by the application of a pair of control voltages to control terminals 27, 28. For example, if a negative voltage is applied to control terminal 27, and control terminal 28 is maintained at zero volts, then PIN diode 18 will be in the on-state, and PIN diode 20 will be in the off-state. Thus, TX signals entering the switch at port 14, will be able to pass through the on-state PIN diode 18 directly to the antenna 12, the TX signal will be simultaneously blocked from the RX port 16 by the off-state PIN diode 20. Conversely, if control terminal 27 is maintained at zero volts, and if a negative voltage is applied to control terminal 28, then RX signals entering the switch at the common antenna 12, will be fed directly to the RX port 16, and will be isolated from the TX port 14.

Another embodiment of an SP2T RF switch is depicted by Ertel in FIG. 6 of U.S. Pat. No. 3,475,700; this comprises two parallel connected PIN diodes 166,178, which are switched between respective on-states and off-states by the application of suitable control voltages to control terminals 170, 176, 182. The operation of the SP2T RF switch depicted by Ertel in FIG. 6 of U.S. Pat. No. 3,475,700 is broadly similar to the SP2T RF switch of FIG. 1 of U.S. Pat. No. 3,475,700, except that in the embodiment shown in FIG. 6, the electrical lengths of the pair of microstrip transmission lines between junctions 164 and 158, and between junctions 177 and 158 are both one quarter of a wavelength of the centre frequency of the operating band of the switch. In this way, when one or the other of PIN diodes 166, 178 are in the on-state, the impedance presented at junction 158 by the on-state PIN diode becomes infinitely large, thereby isolating the branch of the circuit including the switched on diode from the antenna 12.

As mentioned above, in each state of operation of an SP2T RF switch, there is a low loss path between the common port of the switch and one of the input/output ports, and simultaneously there is high isolation between the common port of the switch and the other of the input/output ports for RF signals within the operating frequency range of the switch. The principal disadvantage of the various SP2T RF switch embodiments described in U.S. Pat. No. 3,475,700 by Ertel is that the level of isolation offered by each embodiment is limited by the impedance of a single PIN diode in the off-state (FIG. 1) or in the on-state (FIG. 6). Ideally the off-state impedance of a PIN diode is infinite, and the on-state impedance of a PIN diode is zero, this would give rise to infinite isolation for each embodiment, however typical commercially available PIN diodes have an off-state impedance of one or two thousand Ohms, and an on state impedance of one or two Ohms, so that conventional PIN diodes will provide approximately 25 dB of isolation if deployed in the circuits shown in FIG. 1 or FIG. 6 of U.S. Pat. No. 3,475,700.

The isolation of an SP2T PIN diode RF switch can be improved to approximately 40dB if 4 PIN diodes are employed in the switch circuit, two in each circuit branch of the switch. One such SP2T RF switch is described by Kato et al in U.S. Pat. No. 5519364. The switch depicted by Kato et al in FIG. 1 of U.S. Pat. No. 5,519,364 is a high isolation SP2T RF switch comprising a pair of shunt PIN diodes in each circuit branch. Another type of SP2T switch architecture is described by Iwata et al, in U.S. Pat. No. 4,220,874. Iwata et al describe a number of embodiments of SP1IT and SP2T RF switches which employ a shunt PIN diode and a series PIN diode in each circuit branch. The SP2T RF switch depicted by Iwata et al in FIG. 4 of U.S. Pat. No. 4,220,874 comprises a pair of shunt PIN diodes D₂, D₄ and a pair of series PIN diodes D₁, D₃. The biasing of diodes D1, D₂, D₃ and D₄ is achieved by application of a positive voltage (denoted by V₁ in U.S. Pat. No. 4,220,874) or zero volts (denoted by V₂ in U.S. Pat. No. 4,220,874) to control terminals S₁ and S₂ of the switch. The use of two PIN diodes per circuit branch as illustrated in U.S. Pat. No. 5,519,364 and U.S. Pat. No. 4,220,874 offers a substantial increase in the isolation of the switch. FIG. 1 shows a prior art SP2T RF switch according to the embodiment depicted by Iwata et al in FIG. 4 of U.S. Pat. No. 4,220,874.

The SP2T RF switch of FIG. 1 comprises 3 ports: a common port P₁, a first input/output port P₂, and a second input/output port P₃. The switch includes two circuit branches B₁, B₂, where input/output port P₂ is connected to the one end of circuit branch B₁, and where input/output port P₃ is connected to one end of circuit branch B₂, and where the other ends of both circuit branches B₁ and B₂ are connected to the common port P₁. A pair of control voltages applied to control terminals V₁ and V₂ can set the switch in a first state of operation or a second state of operation according to the logic table given below.

TABLE 1
Logic table for prior art SP2T PIN diode switch of FIG. 1.

| Switch State | V₁ | V₂ | Circuit branch B₁ | Circuit branch B₂ |
|---|---|---|---|---|
| First State | 0 V | 5 V | Low Loss between | High Isolation |
| of Operation | | | P₁ and P₂ | between P₁ and P₃ |
| Second State | 5 V | 0 V | High Isolation | Low Loss between |
| of Operation | | | between P₁ and P₂ | P₁ and P₃ |

The switch of FIG. 1 includes PIN diodes D₁, D₂, D₃, D₄, where D₁ and D₂ are the respective shunt and series PIN diodes of circuit branch B₁ and where D₃ and D₄ are the respective shunt and series PIN diodes of circuit branch B₂

The switch further includes DC blocking capacitors C₁, C₂, C₃, C₄, C₅, C₆ which are selected so they have a very low impedance for RF signals within the operating frequency range of the switch. DC biasing components C₇ and L₃ provide a noise free DC voltage at node M, and DC biasing components C₈ and L₄ provide a noise free DC voltage at node N. DC biasing component L₁ provides a path to ground, via R₁, for a DC current arising from a nonzero voltage at node G, and similarly DC biasing component L₂ provides a path to ground, via R₂, for a DC current arising from a nonzero voltage at node H. Resistor R₁ is selected to regulate the current which can flow from node G to ground when a DC voltage is present at node G, and resistor R₂ is selected to regulate the current which can flow from node H to ground when a DC voltage is present at node H.

In the first state of operation of the RF switch of FIG. 1, diodes D₂ and D₃ are forward biased, and diodes D₁ and D₄ are reverse biased. An RF signal entering circuit branch B₁ of the switch at port P₂, will be substantially unaffected by reverse biased shunt PIN diode D₁ connected to node G, will pass through the forward biased series PIN diode D₂, will be isolated from circuit branch B₂ by reverse biased series PIN diode D₄, and hence will pass without significant attenuation to port P₁ of the SP2T RF switch of FIG. 1.

Any small percentage of the RF signal which can pass through reverse biased series PIN diode D₄ (due to the finite impedance of the reversed biased PIN diode D₄), will have a low resistance path to ground at node H via forward biased shunt PIN diode D₃ and capacitor C₆ (recall that the value of C₆ is chosen to be sufficiently large so that it has a low impedance for RF signals within the operating frequency range of the switch). Hence, the RF signal which enters the switch at P₂ will be highly isolated from port P₃ of the switch.

Consequently, in the first state of operation of the SP2T RF switch of FIG. 1, an RF signal entering the switch at port P₂, will pass without significant attenuation to common port P₁ of the switch and will be highly isolated from port P₃ of the switch. Similarly, an RF signal entering the switch at common port P₁, will pass without significant attenuation to port P₂ of the switch, and will be highly isolated from port P₃ of the switch.

In the second state of operation of the RF switch of FIG. 1, diodes D₁ and D₄ are forward biased, and diodes D₂ and D₃ are reverse biased. An RF signal entering circuit branch B₂ of the switch at port P₃, will be unaffected by reverse biased shunt PIN diode D₃ connected to node H, will pass through the forward biased series PIN diode D₄, will be isolated from circuit branch B₁ by reverse biased series PIN diode D₂, and hence will pass without significant attenuation to port P₁.

Any small percentage of the RF signal which can pass through reverse biased series PIN diode D₂, will have a low resistance path to ground at node G via forward biased shunt PIN diode D₁ and capacitor C₅. Hence, the RF signal which enters the switch at P₃ will be highly isolated from port P₂ of the switch.

Consequently, in the second state of operation of the SP2T RF switch of FIG. 1, an RF signal entering the switch at port P₃, will pass without significant attenuation to common port P₁ of the switch and will be highly isolated from port P₂ of the switch. Similarly, an RF signal entering the switch at common port P₁, will pass without significant attenuation to port P₃ of the switch, and will be highly isolated from port P₂ of the switch.

The SP2T RF switch depicted in FIG. 1 above operates very well within the frequency range of current worldwide cellular systems. However, at very high operating frequencies, such as the frequency band allocated for RF based automotive collision avoidance systems (centered at 24.125 GHz), a number of problems are encountered with the practical implementation of the SP2T RF switch depicted in FIG. 1.

As noted above, in the first state of operation of the SP2T RF switch of FIG. 1, an RF signal entering the switch at port P₂ is unaffected by the path of the circuit from node G to ground via reverse biased PIN diode D₁ and capacitor C₅ because of the high impedance presented by the reverse biased PIN diode D₁ connected to node G. This high impedance can be represented by a reflection co-efficient of +1 at node G due to the circuit path containing PIN diode D₁ and capacitor C₅.

In the second state of operation of the SP2T RF switch of FIG. 1, the high isolation of port P₂ from signals entering the switch at port P₃ or port P₁ is achieved by the combination of the high impedance of reversed biased series PIN diode D₂, and the low impedance path to ground at node G through forward biased shunt PIN diode D₁ and via capacitor C₅. The low impedance path to ground at node G via PIN diode D₁ and capacitor C₅ can be represented by a reflection co-efficient of −1.

In practical implementations, diode D₁ and capacitor C₅ will be soldered to a PCB and the PCB will include a first metal track which connects node G to the cathode of PIN diode D₁ and a second metal track which connects the anode of diode D₁ to capacitor C5.

These metal tracks will have a finite length, and the effect of these metal tracks will be to rotate the phase of the reflection co-efficient at node G due to the path containing PIN diode D₁ and capacitor C₅ so that it will no longer have the ideal value of +1 in the first state of operation of the RF switch of FIG. 1, or −1 in the second state of operation. The phase rotation caused by the finite lengths of metal tracks which connect node G, PIN diode D₁ and capacitor C₅ will introduce a substantial loss due to the reverse biased PIN diode D₁ in the first state of operation of the SP2T RF switch of FIG. 1 and will substantially reduce the isolation offered by the forward biased PIN diode D₃ in the second state of operation of the SP2T RF switch of FIG. 1.

At operating frequencies of 24 GHz, a metal track length of only 1 mm or 2 mm will have a significant effect on the phase of the reflection co-efficient at node G, thereby substantially increasing the loss between ports P₁ and P₂ and substantially reducing the isolation between ports P₁ and P₃ in the first operation state of the SP2T RF switch of FIG. 1.

A similar analysis reveals that the effect of the finite lengths of metal tracks required to connect node H, PIN diode D₃ and capacitor C₆ substantially increases the loss between ports P₁ and P₃, and substantially reduces the isolation between ports P₁ and P₂ in the second operation state of the SP2T RF switch of FIG. 1.

### DISCLOSURE OF THE INVENTION

The invention disclosed herein comprises an RF switch as claimed in claim 1.

### BRIEF DESCRIPTION OF THE DRAWINGS

Embodiments of the invention will now be described, by way of example, with reference to the accompanying drawings in which:

FIG. 1 shows a prior art SP2T PIN diode switch;

FIG. 2 shows a SP2T PIN diode switch of the first preferred embodiment of the present invention;

FIG. 3 shows a SP2T PIN diode switch of the second embodiment of the present invention;

FIG. 4 shows a PI-type discrete LC network of FIG. 3 in more detail;

FIG. 5 shows a SP1T PIN diode switch of the third embodiment of the present invention;

FIG. 6 shows a SP3T PIN diode switch of the fourth embodiment of the present invention; and

FIG. 7 shows a SP2T PIN diode switch of the fifth embodiment of the present invention.

### DESCRIPTION OF PREFERRED EMBODIMENTS OF THE INVENTION

The invention disclosed herein is illustrated primarily by SP2T embodiments as the structure of an SP2T switch is convenient for the description of the main features of the invention, and for highlighting the differences between the invention disclosed and prior art RF switches. However the invention applies equally to SPNT RF switches (where N=1, N=3, N=4, etc) as it does to the SP2T RF switch.

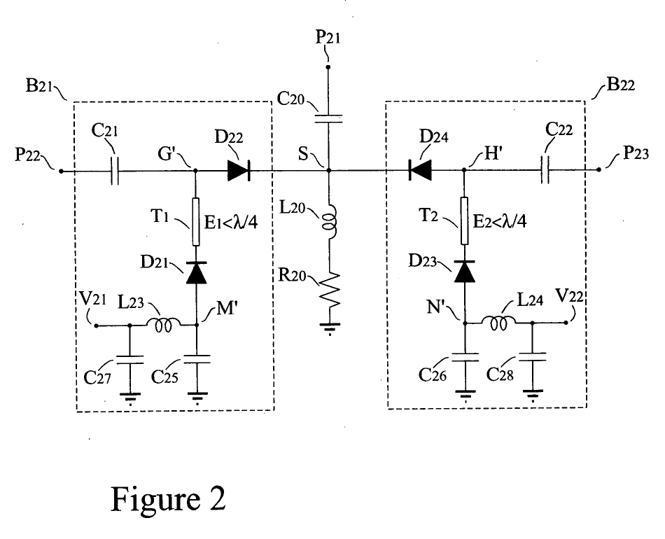

FIG. 2 shows a SP2T RF switch according to a first preferred embodiment of the present invention. The SP2T RF switch of FIG. 2 is a 3 port device comprising a pair of input/output ports P₂₂, P₂₃, and a common port P₂₁. The switch includes two circuit branches B₂₁, B₂₂, where input/output port P₂₂ is connected to one end of circuit branch B₂₁, and where input/output port P₂₃ is connected to one end of circuit branch B₂₂, and where the other ends of both branches B₂₁ and B₂₂ are connected to a common node S.

The switch of FIG. 2 includes PIN diodes D₂₁, D₂₂, D₂₃, D₂₄, where D₂₁ and D₂₂ are the respective shunt and series PIN diodes of circuit branch B₂₁ and where D₂₃ and D₂₄ are the respective shunt and series PIN diodes of circuit branch B₂₂.

The switch includes DC blocking capacitors C₂₀, C₂₁, C₂₂, C₂₅, C₂₆ which are selected so they have a very low impedance for RF signals within the operating frequency range of the switch. DC biasing components C₂₇ and L₂₃ provide a noise free DC voltage at node M′, and DC biasing components C₂₈ and L₂₄ provide a noise free DC voltage at node N′. DC biasing component L₂₀ provides a path to ground via R₂₀ for a DC current arising from a nonzero voltage at node S, and resistor R₂₀ is selected to regulate the current which flows to ground from node S when a DC voltage is present at node S.

The switch further includes a pair of transmission lines T₁ and T₂ which are connected between node G′ and shunt PIN diode D₂₁, and between node H′ and shunt PIN diode D₂₃ respectively. Transmission lines T₁ and T₂ are included in the SP2T RF switch of FIG. 2 to rotate the phase of the reflection co-efficient at node G′ due to the path to ground via components T₁, D₂₁, C₂₅, and to rotate the phase of the reflection co-efficient at node H′ due to the path to ground via components T₂, D₂₃ and C₂₆ respectively.

It was noted earlier that a the reflection co-efficient arising from a very low impedance path to ground (or a short circuit) is −1, and that the reflection co-efficient arising from a very high impedance path to ground (or open circuit) is +1. In both cases, the magnitude of the reflection co-efficient has a value of unity, and the difference is just the phase of the reflection co-efficient.

The effect of connecting a first end of a finite length of metal track or a transmission line to a short circuit or to an open circuit is to rotate the phase of the reflection coefficient at the second end of the metal track by a particular angle. More generally, the effect of connecting a first end of a finite length of metal track to some point in a circuit which gives rise to a reflection co-efficient of Γ₁, where the magnitude of Γ₁, is unity, is to rotate the phase of the reflection co-efficient at the second end of the length of metal track by an angle θ, so that it is given by the expression for Γ₂ in equation 1 below.
Γ₂=Γ₁×e^{-iθ} 1

Specifically, if a first end of a finite length of metal track with a length l is connected to some point in a circuit which gives rise to a reflection co-efficient of Γ₁, the angle of rotation θ(in degrees) of the reflection co-efficient at the second end of the metal track is given by the expression in equation 2 below

$$θ = \frac{180}{π} \times \frac{2 ω l}{c} \qquad 2$$

where ω is the operating frequency and where c is the phase velocity of the propagation of an electromagnetic wave along the metal track.

In the case where the electrical length of the metal track is equal to one quarter of the wavelength of the operating frequency in question, the reflection co-efficient at the second end of the metal track will be rotated by 180 degrees, so that the reflection coefficients at each end of the length of metal track are given by the expression in equation 3 below.
Γ₂=−Γ₁ 3

Consider the case when PIN diodes D₂₁, and D₂₃ of the SP2T RF switch of FIG. 2 are reverse biased; in this case the PIN diodes D₂₁, and D₂₃ will each present a high impedance: D21 in the path from node G′ to ground, and D₂₃ in the path from node H′ to ground. The reflection co-efficient at node G′ due to the path containing components T₁, D₂₁, C₂₅ will be determined by the very high impedance of PIN diode D₂₁, connected in series with transmission line T₁, and any metal tracks required to connect PIN diode D₂₁ to transmission line T₁ and to connect transmission line T₁ to node G′ (which are also connected in series with components T₁, D₂). Similarly the reflection co-efficient at node H′ due to the path containing components T₂, D₂₃, C₂₆ will be determined by the very high impedance of PIN diode D₂₃, connected in series with transmission line T₂, and any metal tracks required to connect PIN diode D₂₃ to transmission line T₂ and to connect transmission line T₂ to node H′ (which are also connected in series with components T₁, D₂).

Hence, at node G′ the reflection co-efficient will given by equation 1, where Γ₁, will be approximately +1 (due to the high impedance of the reverse biased PIN diode D₂₁) and where θ will be equal to the sum of the phase rotations due to the length of metal track required to connect the cathode of PIN diode D₂₁ to one end of transmission line T₁, the phase rotation due to transmission line T₁ itself, and the phase rotation due to the length of metal track required to connect the other end transmission line T₁ to node G′. In the present invention, the length of transmission line T₁ is chosen so that θ is 180 degrees. Thus, the reflection co-efficient at node G′ due to the path containing components T₁, D₂₁, C₂₅ will be −1 when PIN diode D₂₁ is in the on-state.

Similarly the length of transmission line T₂ is chosen so that the sum of the phase rotations due to the length of metal track required to connect the cathode of PIN diode D₂₃ to one end of transmission line T₂, the phase rotation due to transmission line T₂ itself, and the phase rotation due to the length of metal track required to connect the other end of transmission line T₂ to node H′ is also 180 degrees. Hence the reflection co-efficient at node H′ due to the path containing components T₂, D₂₃, C₂₆ will also be −1 when PIN diode D₂₃ is in the on-state.

Since the path from node G′ to ground includes the metal tracks which are required to physically connect node G′ to transmission line T₁, and to connect transmission line T₁ to PIN diode D₂₁ as described above, the electrical length E₁ of transmission line T₁ is necessarily less than one quarter of the wavelength of the centre frequency of the operating band of the switch. Similarly, since the path from node H′ to ground includes the metal tracks which are required to physically connect node H′ to transmission line T₂, and to connect transmission line T₂ to PIN diode D₂₃, the electrical length E₂ of transmission line T₂ is also necessarily less than one quarter of the wavelength of the centre frequency of the operating band of the switch. This is illustrated by the expression E₁<λ/4 adjacent to transmission line T₁ and the expression E₂<λ/4 adjacent to transmission line T₂ in FIG. 2.

A reflection co-efficient of −1 is that which arises from an infinitely small impedance to ground, so it can be seen that in the SP2T RF switch of FIG. 2, the pin diodes D₂₁ and D₂₃ will present very low impedances at nodes G′ and H′ when they are reverse biased.

Now, consider the case when PIN diodes D₂₁, and D₂₃ of the SP2T RF switch of FIG. 2 are forward biased; in this case the PIN diodes D₂₁, and D₂₃ each will present low impedances: D₂₁ in the path from node G′ to ground, and D₂₃ in the path from node H′ to ground. The reflection co-efficient at node G′ due to the path to ground via components T₁, D₂₁, C₂₅ will be determined by the very low impedance of capacitor C₂₅, connected in series with the low impedance of PIN diode D₂₁, connected in series with transmission line T₁, and any metal tracks required to connect the components together (which are also connected in series with components T₁, D₂₁, C₂₅). Similarly, the reflection co-efficient at node H′ due to the path to ground via components T₂, D₂₃, C₂₆ will be determined by the very low impedance of capacitor C₂₆, connected in series with the low impedance of PIN diode D₂₃, connected in series with transmission line T₂, and due to any metal tracks required to connect the components together (which are also connected in series with components T₂, D₂₃, C₂₆).

In each case, the reflection co-efficient will given by the expression for Γ₂ in equation 1, where Γ₁ is approximately −1 (due to the low impedance path to ground at the cathode of PIN diode D₂₁ and via capacitor C₂₅ and due to the low impedance path to ground at the cathode of PIN diode D₂₃ via capacitor C₂₆) and where θ is approximately 180 degrees. Thus the reflection co-efficient at node G′ due to the path to ground via components T₁, D₂₁, C₂₅ will be +1, and that at node H′ due to the path to ground via components T₂, D₂₃, C₂₆ will also be +1 when PIN diodes D₂₁ and D₂₃ are forward biased.

A reflection co-efficient of +1 is that which arises from a infinitely large impedance, so it can be seen that in the SP2T RF switch of FIG. 2, the pin diodes D₂₁ and D₂₃ will present very high impedances at nodes G′ and H′ (and hence are effectively isolated from nodes G′ and H′) when they are forward biased.

A pair of control voltages applied to control terminals V₂₁ and V₂₂ can set the SP2T RF switch of FIG. 2 in a first state of operation or a second state of operation according to the logic table given below.

TABLE 2
Logic table for SP2T PIN diode switch of FIG. 2.

| Switch State | V₂₁ | V₂₂ | Circuit branch B₂₁ | Circuit branch B₂₂ |
|---|---|---|---|---|
| First State | 5 V | 0 V | Low Loss between | High Isolation |
| of Operation | | | P₂₁ and P₂₂ | between P₂₁ and P₂₃ |
| Second State | 0 V | 5 V | High Isolation | Low Loss |
| of Operation | | | between P₂₁ and P₂₂ | between P₂₁ and P₂₃ |

In the first state of operation of the SP2T RF switch of FIG. 2, the voltage at the anode of PIN diode D₂₁ (connected to node M′) is 5 Volts, the voltages at the cathode of PIN diode D₂₁ and at the anode of PIN diode D₂₂ (both connected to node G′) are 5−V_{TH} Volts, and the voltage at the cathode of PIN diode D₂₂ (connected to node S) is 5−2×V_{TH} Volts. Hence, both PIN diodes D₂₁ and D₂₂ will be forward biased in the first state of operation of the SP2T RF switch of FIG. 2.

The voltage at the cathode of PIN diode D₂₄, (also connected to node S) is 5−2×V_{TH} Volts and that at the anode of PIN diode D₂₄ (connected to node H′), is given approximately by the expression in equation 4 below.

$${V}_{{H}^{′}} = \frac{1}{2} ( 5 - 2 \times {V}_{TH} ) \qquad 4$$

The expression in equation 4 can be deduced from the fact that diodes D₂₄ and D₂₃ will act as a voltage divider between node S and the potential of zero Volts at control terminal V₂₂.

The voltage at the cathode of PIN diode D₂₃ (also connected to node H′) is also given by the expression in equation 4, and the voltage at the anode of PIN diode D₂₃ i.e. zero Volts—since is this is connected to control terminal V₂₂ which is at zero Volts. Hence both PIN diodes D₂₃, and D₂₄ will be reversed biased in the first state of operation of the SP2T RF switch of FIG. 2.

Consequently, in the first state of operation of the SP2T RF switch of FIG. 2, diodes D₂₁ and D₂₂ will be forward biased, and diodes D₂₃ and D₂₄ will be reverse biased.

The analysis in the preceding section showed that the reflection co-efficient arising from the path to ground from node G′ via transmission line T₁, PIN diode D₂₁, and capacitor C₂₅ will be +1 when PIN diode D₂₁ is forward biased. A reflection co-efficient of +1 is that which arises from a very high impedance path to ground or an open circuit. Therefore, in the first state of operation of the SP2T RF switch of FIG. 2, an RF signal entering circuit branch B₂₁ of the switch at port P₂₂, will be unaffected by the open circuit at node G′, will then pass through the forward biased PIN diode D₂₂, will be isolated from circuit branch B₂₃ by reverse biased PIN diode D₂₄, and hence will pass without significant attenuation to port P₂₁.

The analysis in the preceding section also showed that the reflection co-efficient arising from the path to ground from node H′ via transmission line T₂, PIN diode D₂₃, and capacitor C₂₆ will be −1 when PIN diode D₂₃ is reverse biased. A reflection co-efficient of −1 is that which arises from a very low impedance path to ground or a short circuit. Any small percentage of the RF signal which can pass through reverse biased PIN diode D₂₄ (due to the finite impedance of the reversed biased PIN diode D₂₄), will have a low resistance path to ground at node H′ via transmission line T₂, reverse biased PIN diode D₂₃, and capacitor C₂₆. Hence, the RF signal which enters the switch at P₂₂ will be highly isolated from port P₂₃ of the switch.

In summary, in the first state of operation of the SP2T RF switch of FIG. 2, an RF signal entering the switch at port P₂₂, will pass without significant attenuation to common port P₂₁ of the switch and will be highly isolated from port P₂₃ of the switch. Similarly, an RF signal entering the switch at common port P₂₁, will pass without significant attenuation to port P₂₂ of the switch, and will be highly isolated from port P₂₃ of the switch.

In the second state of operation of the SP2T RF switch of FIG. 2, the voltage at the anode of PIN diode D₂₃ (connected to node N′) is 5 Volts, the voltages at the cathode of PIN diode D₂₃ and at the anode of PIN diode D₂₄ (both connected to node H′) are 5−V_{TH} Volts, and the voltage at the cathode of PIN diode D₂₄ (connected to node S) is 5−2×V_{TH} Volts. Hence, both PIN diodes D₂₃ and D₂₄ will be forward biased in the second state of operation of the SP2T RF switch of FIG. 2.

The voltage at the cathode of PIN diode D₂₂, (also connected to node S) is 5−2×V_{TH} Volts and that at the anode of PIN diode D₂₂ (connected to node G′), is given approximately by the expression in equation 4 above.

The voltage at the cathode of PIN diode D₂₁ (also connected to node G′) is also given by the expression in equation 4, and the voltage at the anode of PIN diode D₂₁ is zero Volts—since this is connected to control terminal V₂₁ which is at zero Volts. Hence both PIN diodes D₂₁, and D₂₂ will be reversed biased in the second state of operation of the SP2T RF switch of FIG. 2.

Consequently, in the second state of operation of the SP2T RF switch of FIG. 2, diodes D₂₃ and D₂₄ will be forward biased, and diodes D₂, and D₂₂ will be reverse biased.

In the second state of operation of the RF switch of FIG. 2, an RF signal entering circuit branch B₂₂ of the switch at port P₂₃, will be unaffected by the open circuit at node H′, will then pass through the forward biased PIN diode D₂₄, will be isolated from circuit branch B₂₂ by reverse biased PIN diode D₂₂, and hence will pass without significant attenuation to port P₂₁.

Any small percentage of the RF signal which can pass through reverse biased PIN diode D₂₂, will have a low resistance path to ground at node G′ via transmission line T₁, reverse biased PIN diode D₂₁, and capacitor C₂₅. Hence, the RF signal which enters the switch at P₂₃ will be highly isolated from port P₂₁ of the switch.

In summary, in the second state of operation of the SP2T RF switch of FIG. 2, an RF signal entering the switch at port P₂₃, will pass without significant attenuation to common port P₂₁ of the switch and will be highly isolated from port P₂₂ of the switch. Similarly, an RF signal entering the switch at common port P₂₁, will pass without significant attenuation to port P₂₃ of the switch, and will be highly isolated from port P₂₂ of the switch.

A surprising benefit of the preferred embodiment of the present invention of FIG. 2 results is from the fact that the PIN diodes are biased in series, as opposed to being biased in parallel in the various embodiments of an SP2T RF switch proposed by Ertel in U.S. Pat. No. 3,475,700 and by Iwata et al in U.S. Pat. No. 4,220,874.

The power consumed by the SP2T RF switch of FIG. 2 in either state is equal to the bias voltage multiplied by the total current flowing through the various paths to ground. For example, in the first state of operation of the SP2T RF switch of FIG. 2, the power is given by the expression in equation 5 below.

$$P = {V}_{21} {i}_{D} = 5 \times \frac{5 - {V}_{D 21} - {V}_{D 22}}{{R}_{20}} \qquad 5$$

Where i_{D} is the current flowing through PIN diodes D₂₁, and D₂₂ in the first state of operation of the switch of FIG. 2, and where V_{D21} and V_{D22} are the voltages across PIN diodes D₂₁ and D₂₂ respectively.

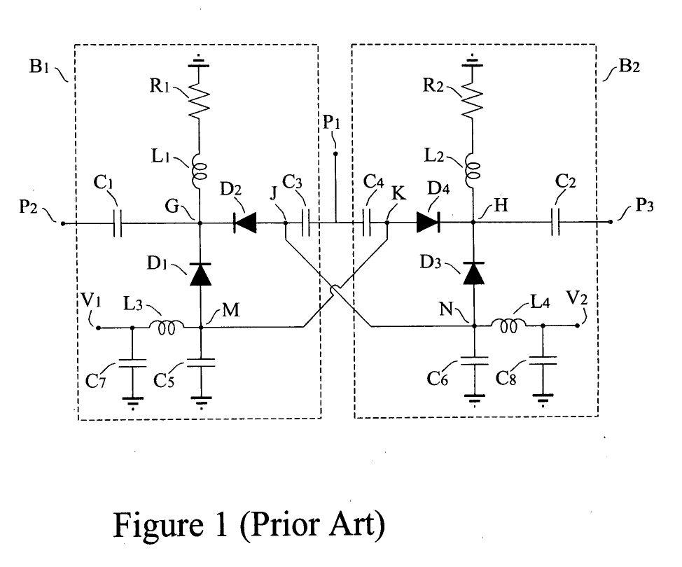

The power consumed by the prior art SP2T RF switch of FIG. 1 in either state is also equal to the bias voltage multiplied by the total current flowing through the various paths to ground. For example, in the first state of operation of the SP2T RF switch of FIG. 1, the power consumed by the switch is given by the expression in equation 6 below.

$$P = {V}_{1} ( {i}_{D 2} + {i}_{D 3} ) = 5 \times ( \frac{5 - {V}_{D 2}}{{R}_{1}} + \frac{5 - {V}_{D 3}}{{R}_{2}} ) \qquad 6$$

Where i_{D2} is the current flowing through PIN diode D₂ and i_{D3} is the current flowing through PIN diode D₃ and where V_{D2} and V_{D3} are the voltages across PIN diodes D₂ and D₃ respectively in the first state of operation of the switch of FIG. 1.

Assuming that the values of R₁, R₂ and R₂₀ are selected so that a given current flows through PIN diodes D₂ and D₃ in the switch of FIG. 1, and so that the same current flows through PIN diodes D₂₁, and D₂₂ in the switch of FIG. 2, then the value of the power consumed given by equation 6 must be two times greater than that given by equation 5, and hence that the SP2T RF switch of the preferred embodiment of the present invention depicted in FIG. 2 will consume half of the power of the prior art SP2T RF switch depicted in FIG. 1.

It can also be seen that the SP2T RF switch of FIG. 2 has a considerably simpler biasing arrangement, than the SP2T RF switch of FIG. 1. In particular, the SP2T RF switch of FIG. 2 includes a single common DC bias inductor L₂₀ which is connected to node S, and this inductor is connected a single common current regulating resistor R₂₀; a single common DC is blocking capacitor C₂₀ is connected between node S and port P₂₁; these three components which are common to circuit branches B₂₁, and B₂₂ of FIG. 2, fulfill the same functionality as the components L₁, L₂, C₃, C₄, and R₁ and R₂ of the SP2T RF switch depicted in FIG. 1.

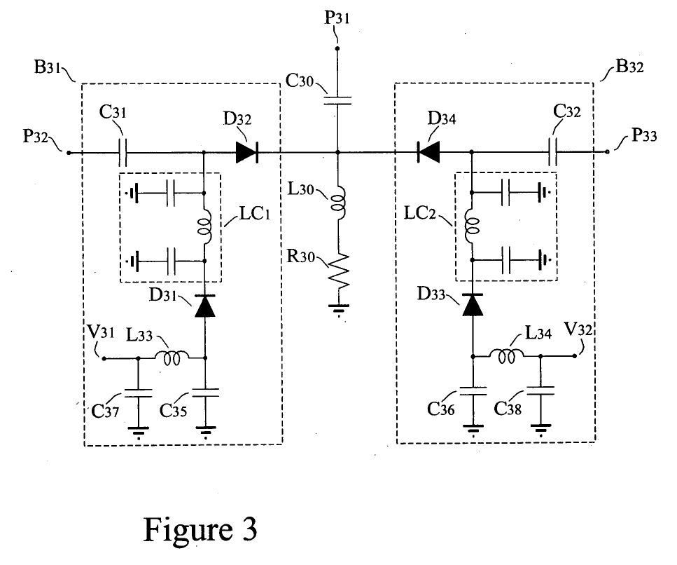

FIG. 3 depicts a second embodiment of the present, wherein transmission lines T₁ and T₂ of the preferred embodiment of FIG. 2 have been replaced by discrete LC PI networks LC₁ and LC₂.

It was noted earlier that the effect of connecting a first end of a finite length of metal track to some point in a circuit which gives rise to a reflection co-efficient of Γ₁, where the magnitude of Γ₁ is unity, is to rotate the phase of the reflection co-efficient at the second end of the length of metal track by an angle θ. More specifically, it was shown that when the length of the metal track is equal to one quarter of the wavelength of the operating frequency in question, the phase of the reflection co-efficient at the second end of the metal track will be rotated by 180 degrees.

Transmission lines T₁ and T₂ in the preferred embodiment of the present invention given in FIG. 2 are each selected so that a phase rotation of 180 degrees would result from the combined length of transmission line T₁ plus any metal tracks required to physically connect diode D₂₁, and capacitor C₂₅ in the path to ground from node G′, and so that a phase rotation of 180 degrees would also result from the combined length of transmission line T₂ plus any metal tracks required to physically connect diode D₂₃ and capacitor C₂₆ in the path to ground from node H′. The 180 degrees phase rotation which results from the combination of lines and tracks transforms a reflection co-efficient of −1 at one end of the combination of lines and tracks to a reflection co-efficient of +1 at the other end, and vice versa.

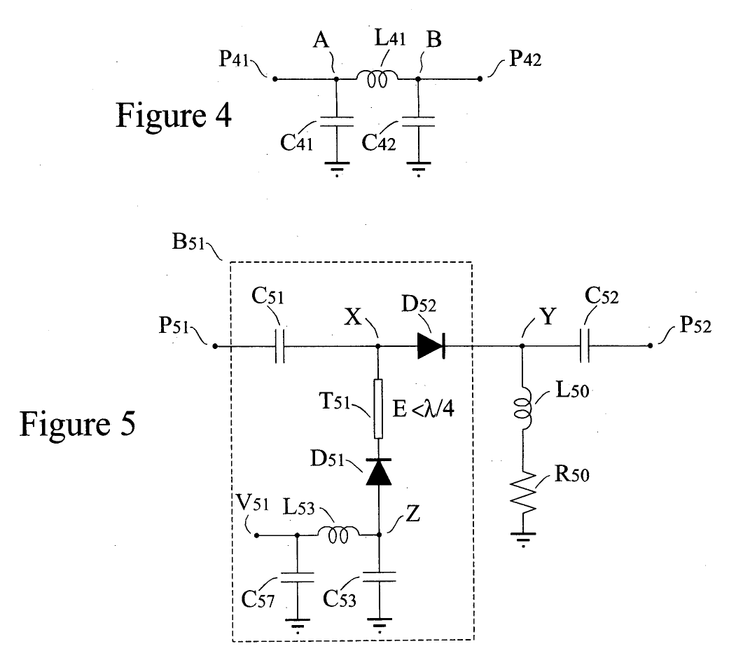

As shown in FIG. 3 and as discussed in more detail in relation to FIG. 4, the same effect can be achieved by a network of discrete components, such as the PI circuits LC₁ and LC₂. Referring to FIG. 4, assume that an impedance which gives rise to a reflection coefficient of either +1 or −1 is connected at port P₄₁ of the PI-type discrete LC network.

For the case where the reflection co-efficient at port P₄₁ is equal to +1, the phase rotation produced by capacitor C₄₁ on the reflection co-efficient at node A will be 90 degrees when the value of capacitor C₄₁ is given by the expression in equation 7 below.

$${C}_{41} = \frac{1}{2 π {f}_{0} {Z}_{0}} \qquad 7$$

where Z₀ is the characteristic impedance of the source into which the reflection co-efficient is measured, and where fo is the frequency of operation.

Similarly, in the PI-type discrete LC network of FIG. 4, a phase rotation of 90 degrees will produced by inductor L₄₁ when the value of inductor L₄₁ is given by the expression in equation 8 below.

$${L}_{41} = \frac{{Z}_{0}}{2 π {f}_{0}} \qquad 8$$

Thus, the combined phase rotation of capacitor C₄₁ and inductor L₄₁ will be equal to 180 degrees, so that the reflection co-efficient at node B due to the impedance at port P₄₁ and due to capacitor C₄₁ inductor L₄₁ will be −1. Since a reflection co-efficient of −1 is equivalent to a short circuit, capacitor C₄₂ will have no effect on the circuit in this case, and the reflection co-efficient at port P₄₂ will be −1 as required.

For the case where the reflection co-efficient at port P₄₁ is equal to −1, capacitor C₄₁ has no effect on the short circuit at node A and L₄₁ will produce a phase rotation of 90 degrees when it's value is given by the expression in equation 8 as before.

In this case, the phase rotation produced by capacitor C₄₂ will be 90 degrees when the value of capacitor C₄₂ is given by the expression in equation 9 below.

$${C}_{42} = \frac{1}{2 π {f}_{0} {Z}_{0}} \qquad 9$$

Thus the combined phase rotation of inductor L₄₁ and capacitor C₄₂ will be equal to 180 degrees, so that the reflection co-efficient at node B due to the impedance at port P₄₁ and due to inductor L₄₁ and capacitor C₄₂ will be +1 as required.

If the values of the capacitors and inductors in discrete LC networks LC₁ and LC₂ in the embodiment of the SP2T RF switch of FIG. 3 are chosen so that they are slightly less than the values given in equations 7, 8 and 9, (a slight reduction is required to allow for the finite lengths of metal tracks which are required to physically connect the components together as before), the circuit of FIG. 3 will have the same electrical characteristics as the preferred embodiment of the present invention given by the circuit of FIG. 2.

The simplest form of RF switch is the SP1T switch. An SP1T RF switch has a first input/output RF port, and a second input/output RF port and furthermore has two states of operation: an on state, whereby a low insertion loss path exists between the first and second input/output ports of the switch for RF signals within the operating frequency range of the switch, and an off state, whereby there is high isolation between the first and second input/output ports of the switch for RF signals within the operating frequency range of the switch.

An SP1T RF switch according to the present invention is given in FIG. 5. The circuit of FIG. 5 is an SP1T RF switch including a first input/output port P₅₁, and a second input/output port P₅₂. The circuit of FIG. 5 comprises a shunt PIN diode D₅₁, and a series PIN diode D₅₂, the circuit further includes DC blocking capacitors C₅₁, C₅₂ and C₅₃. The anode of PIN diode D₅₁ is connected to ground via DC blocking capacitor C₅₃, and the cathode of diode D₅₁ is connected to node X of the circuit via transmission line T₅₁. As with the SP2T switch of the preferred embodiment of the present invention, illustrated in FIG. 2, the length of transmission line T₅₁ is chosen so that a combined phase rotation of 180 degrees results from the metal track required to physically connect the cathode of PIN diode D₅₁ to transmission line T₅₁, from the transmission line T₅₁ itself, and from the metal track required to connect transmission line T₅₁ to node X of the circuit. As before, this arrangement gives rise to a reflection co-efficient of +1 at node X of the circuit due to the path to ground via transmission line T₅₁, PIN diode D₅₁, and capacitor C₅₃ when PIN diode D₅₁ is in its on-state, and similarly gives rise to a reflection co-efficient of −1 at node X of the circuit due to the path to ground via transmission line T₅₁, PIN diode D₅₁, and capacitor C₅₃ when PIN diode D₅₁ is in its off-state.

DC biasing components inductor L₅₀ and resistor R₅₀ are coupled to node Y of the circuit. A single voltage control terminal V₅₁ is coupled to node Z of the circuit via DC biasing components inductor L₅₃ and capacitor C₅₇.

The SP1T RF switch of FIG. 5 is in its on-state when a positive voltage is applied at control terminal V₅₁; the switch of FIG. 5 is in its off-state when a negative voltage or when zero volts are applied at control terminal V₅₁.

A prior art embodiment of an SP1T RF switch is illustrated by Iwata et al in FIG. 1 of U.S. Pat. No. 4,220,874. It will be noted that the SP1T of FIG. 5 of the present invention is substantially different from the SP1T illustrated by Iwata et al in FIG. 1 of U.S. Pat. No. 4,220,874. In addition to providing an SP1T RF switch suitable for high frequency operation (say 24 GHz) the present invention offers an SP1T switch which only draws current in its on-state. This is a considerable benefit in RF switch applications where the switch is required to be in its off-state for a larger percentage of the time than it is required to be in its on-state and in particular for battery powered RF applications.

As was the case for the SP2T RF switch of the preferred embodiment of the present invention, the SP1T RF switch of FIG. 5 consumes half the power of the SP1T switch illustrated by Iwata et al in FIG. 1 of U.S. Pat. No. 4,220,874 when both switches are in the on-state.

Because of the relatively simple biasing circuit required in the preferred embodiment of the present invention given in FIG. 2 or the alternative of FIG. 3; the addition of extra circuit branches to create SPNT RF switch (where N is greater than 2) is simply a matter of creating additional circuit branches where the components in the additional circuit branches have the same layout and same values as those of circuit branch B₂₁ or B₂₂ of the SP2T RF switch of FIG. 2; or circuit branch B₃₁ or B₃₂ of the SP2T RF switch of FIG. 3.

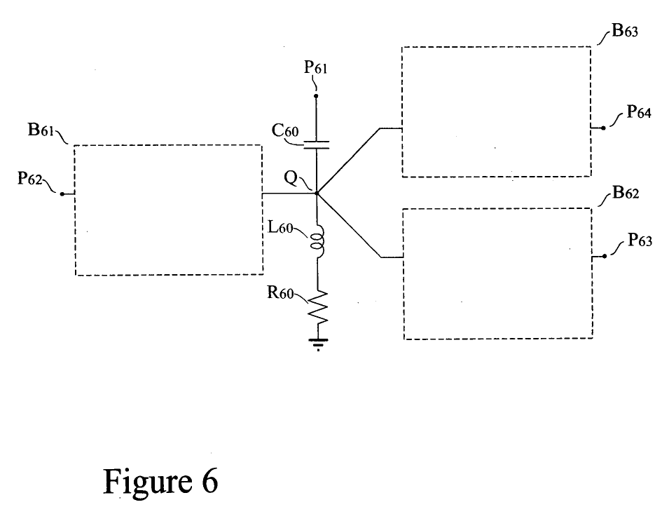

So, for example, an SP3T RF switch based on the present invention is shown in FIG. 6. The SP3T RF switch of FIG. 6 is a 4 port device comprising input/output ports P₆₂, P₆₃, P₆₄, and common port P₆₁. The switch includes three circuit branches B₆₁, B₆₂, B₆₃, comprising either the circuitry of branches B₂₁, B₂₂; or B₃₁, B₃₂ , and where input/output port P₆₂ is connected to one end of circuit branch B₆₁, input/output port P₆₃ is connected to one end of circuit branch B₆₂, input/output port P₆₄ is connected to one end of circuit branch B₆₃ and where the other ends of branches B₆₁, B₆₂, B₆₃, are connected to a common node Q.

In the first four embodiments of the present invention, PIN diodes were employed as the active devices which enabled switching between the states of operation of each embodiment.

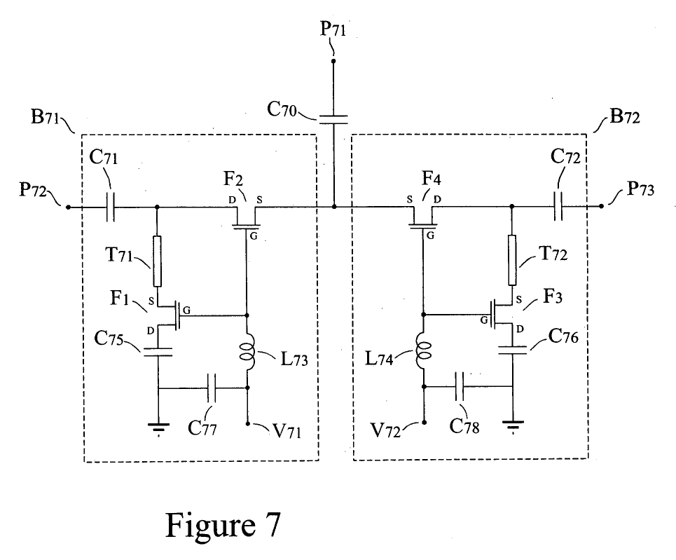

The invention disclosed herein is not limited to embodiments employing PIN diodes. Any active device which can present a low resistance path between two ports of the device in one state, and which can alternatively present a high resistance path between the same two ports in another state of the device could be employed in the invention disclosed herein. For example, FIG. 7 depicts a SP2T RF switch where PIN diodes D₂₁ D₂₂, D₂₃ and D₂₄ of the preferred embodiment of FIG. 2, have been replaced by field effect transistors F₁, F₂, F₃, and F₄. As well as in the branch biasing circuitry, appropriate changes are required to the common circuitry by replacing the RLC networks of FIGS. 2-4 and 6 with the capacitor C₇₀. FETs F₁, F₂, F₃, and F₄ in the embodiment depicted in FIG. 7 could, for example, be n-channel enhancement mode MOSFETs, which are made to conduct from drain to source when the gate voltage is made positive relative to the source voltage and which become open circuit between the source and the drain when the gate voltage is equal to or negative relative to the source.

In FIG. 7, it can be seen that when V₇₁ is at +V Volts, and when V₇₂ is at 0 Volts, the gate of FET F₁ will be positive relative to its source, and similarly the gate of FET F₂ will be positive relative to its source; at the same time the gate of FET F₄ will be negative relative to its source, and that of FET F₃, will be at the same potential as the source. Hence, FET F₁ and FET F₂ will be in the on-state and FET F₃ and FET F₄ will be in the off-state. Comparison of the circuit of FIG. 7 as described above with that of FIG. 2 reveals that the RF characteristics between ports P₇₁, P₇₃ and P₇₃ of the SP2T RF switch of FIG. 7 are the same as those between ports P₂₁, P₂₂, and P₂₃ of the SP2T RF switch of FIG. 2, when the SP2T RF switch of FIG. 2 is in its first state of operation.

As in the case of the first and second embodiments, it will be seen that the branches B₇₁, B₇₂ of FIG. 7 can be used to implement SPNT switches as described with reference to FIG. 6 in particular.

1. An RF switch having at least two operating states and comprising at least one circuit branch, wherein the at least one circuit branch comprises:
a first input/output port connected to
a second input/output port via
a series active device,
a phase shifting component connected in series with
a shunt active device, so that when the shunt active device is in an on state, the reflection co-efficient due to a path to ground from said series active device via said phase shifting component and the shunt active device is +1, and
at least one control terminal to which a DC bias can be applied to control the state of the active devices, whereby in one of the operating states of the switch, both active devices are in the on state simultaneously, and in another of the operating states, both active devices are in an off state simultaneously.

2. The RF switch of claim 1 comprising a node adjacent to the first input/output port to which both the series active device and the phase shifting component are connected.

3. The RF switch of claim 1 wherein said shunt device is connected to said node via said phase shifting component.

4. The RF switch of claim 1 wherein said active devices are PIN diodes.

5. The RF switch of claim 1 wherein said active devices are field effect transistors.

6. The RF switch of claim 1 wherein said phase shifting component is selected from the group of: transmission line and PI network.

7. An SPNT switch comprising the RF switch of claim 1 having N circuit branches.

8. An antenna switch module (ASM) comprising an SPNT switch according to claim 7, each circuit branch second input/output port being connected to an antenna port via a common blocking capacitor.

9. An ASM as claimed in claim 8, wherein said active devices are PIN diodes, and wherein said blocking capacitor is connected to ground via a resistor/inductor network.
